(19) United States
(12) Patent Application Publication
(10) Pub. No.: US 2007/0168904 A1
(43) Pub. Date: Jul. 19, 2007

(54) Architecture to simplify development of out of box experience (OOBE) modules

(76) Inventors: Wei Yuan, Shanghai (CN); James A. Howell JR., Georgetown, TX (US); Yi Qi Xu, Shanghai (CN); Fengshu Yang, Austin, TX (US)

Correspondence Address: HAMILTON & TERRILE, LLP, P.O. BOX 203518, AUSTIN, TX, 78720, US

(21) Appl. No.: 11/314,662

(22) Filed: Dec. 20, 2005

(51) Int. Cl. G06F 9/44

(52) U.S. Cl. 717/100

(57) ABSTRACT

A method for providing an out of box experience (OOBE) which includes providing an OOBE module and an OOBE variables file, providing OOBE options to the OOBE module via the OOBE variables file, customizing the out of box experience via the OOBE options in the OOBE variables file, and presenting the out of box experience via the OOBE module is disclosed.

### BACKGROUND OF THE INVENTION

1. Field of the Invention

The present invention relates to the field of out of box experiences modules and more particularly to an architecture for simplifying development of out of box experience modules.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Under known out of box experience structures, such as the OOBE structure defined by Microsoft, developing an OOBE module for a particular type of information handling system can be very time consuming. This issue is especially prevalent when frequent changes are desirable such as for systems that are fabricated in a build to order manufacturing environment. An advantage of a build to order manufacturing environment is that an information handling system design can be easily changed in response to changes in the market. This advantage is limited if the time that it takes to modify an information handling system's OOBE module is relatively longer than the time that it takes to modify the design of the information handling system.

It is desirable to provide customized out of box experiences for certain types of transactional customers. A customized out of box experience provides a better customer experience and maximizes the value of the manufacturer that can provide such an experience. However, the known out of box experience structure presents a number of challenges.

For example, OOBE development using a known OOBE architecture can require three to five days to complete. Every change (whether a large change or a small change) requires a new OOBE module. Additionally OOBE development validation can present a challenge that is time consuming in a factory download environment. Additionally, the known OOBE structure does not conform to an install shield specification nor a “Windows” MSI specification. The known OOBE structure is difficult to implement and install within a build to order factory install script. The known OOBE structure does not conform to known factory install tools.

For example, FIG. 1, labeled Prior Art, shows a flow diagram of the various files used within an OOBE module. More specifically, when installing an OOBE module during a factory install process 110, the OOBE module files (OOBEINIT.EXE) are copied to an information handling system. When the OOBE module is launched (via, e.g., MSOOBE.EXE), any changes to the OOBE module would require hard code changes 112 (i.e., changes to the instructions within the OOBE module). For example, if the OOBE module were setting forth an internet service provider (ISP) registration configuration, any changes to the configuration would require hard code changes. For any flow control or variable definition changes 114 (via, e.g., MSOBSHEL.HTM) hard code changes and additional branch processing would be required. For any OOBE module driven pages (such as e.g., ISP registration customized pages), option changes and page edits would require hard code changes which would add related statements in each .HTM file of the OOBE module.

FIG. 2, labeled Prior Art, shows a customized OOBE module development process. More specifically, the development process is often initiated by marketing requesting a change to the OOBE module 210 such as changing an ISP registration process. The requested change results in an OOBE core team discussion 212 about how to implement then change within an OOBE module. After a strategy for implementing the change is determined, then development of the modified OOBE module is arranged 214. Next a customized version of the OOBE module is developed 220. The core team then reviews the development 222 to determine whether the customized version of the OOBE module meets the requirements of the requested change 224. If not, then the OOBE module continues development 220. (An OOBE module can often require three to five iterations to meet the requirements of the requested change, either because the requirements are modified or some other business reason.) Once the module meets the requirements of the marketing request, then the OOBE module enters a test process 230 before being deployed for factory install.

### SUMMARY OF THE INVENTION

In one embodiment, the invention relates to a method for providing an out of box experience (OOBE) which includes providing an OOBE module and an OOBE variables file, providing OOBE options to the OOBE module via the OOBE variables file, customizing the out of box experience via the OOBE options in the OOBE variables file, and presenting the out of box experience via the OOBE module.

In another embodiment, the invention relates to a method for developing an out of box experience (OOBE) which includes providing an OOBE module and an OOBE variables file, standardizing the OOBE module, customizing the out of box experience with OOBE options via variables in the OOBE variables file, providing the variables in the OOBE variables file to the OOBE module, and presenting the out of box experience via the OOBE module.

In another embodiment, the invention relates to a method for installing an out of box experience (OOBE) module onto an information handling system which includes executing an OOBE initialization module wherein the OOBE initialization module accesses a component identifier to identify a particular out of box experience, copying an OOBE module onto the information handling system, and copying variables from the OOBE variables file based upon the component identifier wherein the variables cause the OOBE module to execute in accordance with OOBE options and the OOBE options define the particular out of box experience.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1, labeled Prior Art, shows a flow diagram of the various files used within an out of box experience module.

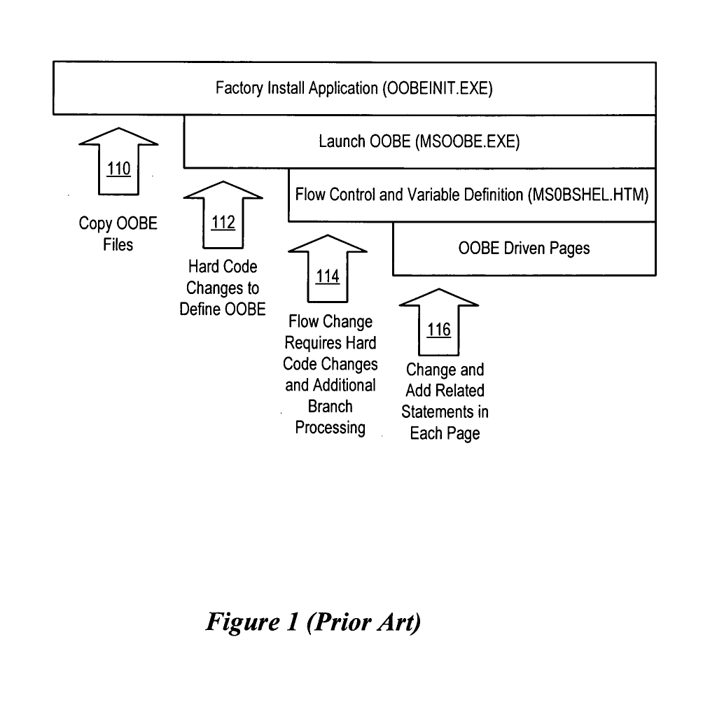

FIG. 2, labeled Prior Art, shows a block diagram of a process for developing an out of box experience module.

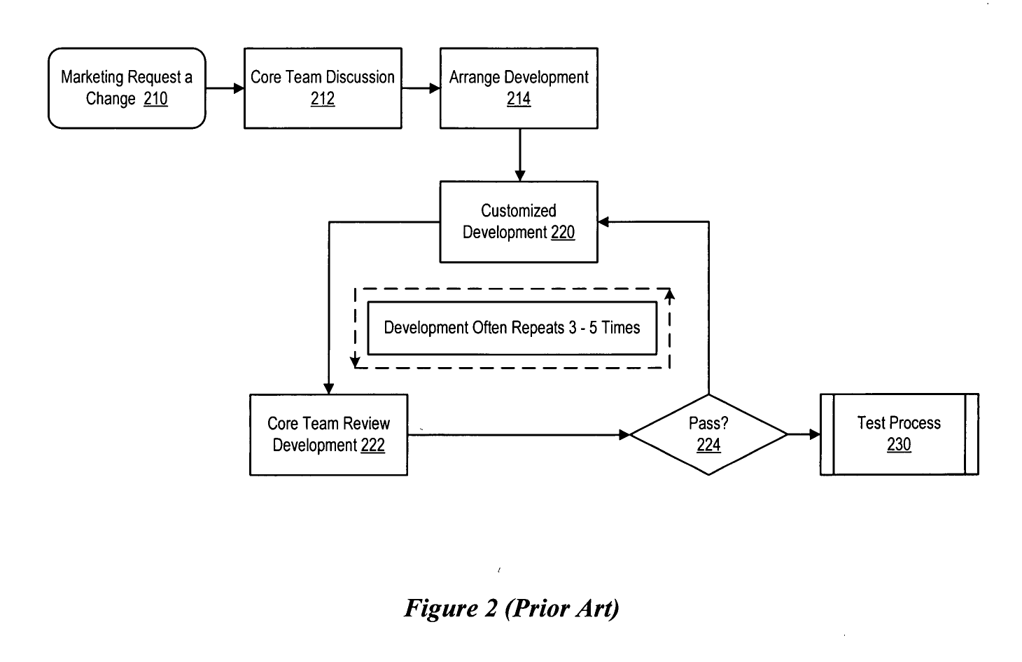

FIG. 3 shows a flow diagram of the various files used within an out of box experience module.

FIG. 4 shows a flow diagram of an example process for developing an out of box experience module.

FIG. 5 shows a flow diagram of the configuration of an information handling system to include the out of box experience module.

FIG. 6 shows a flow diagram of an out of box experiences module factory install process.

FIG. 7 shows a block diagram of an information handling system with an out of box experience module.

### DETAILED DESCRIPTION

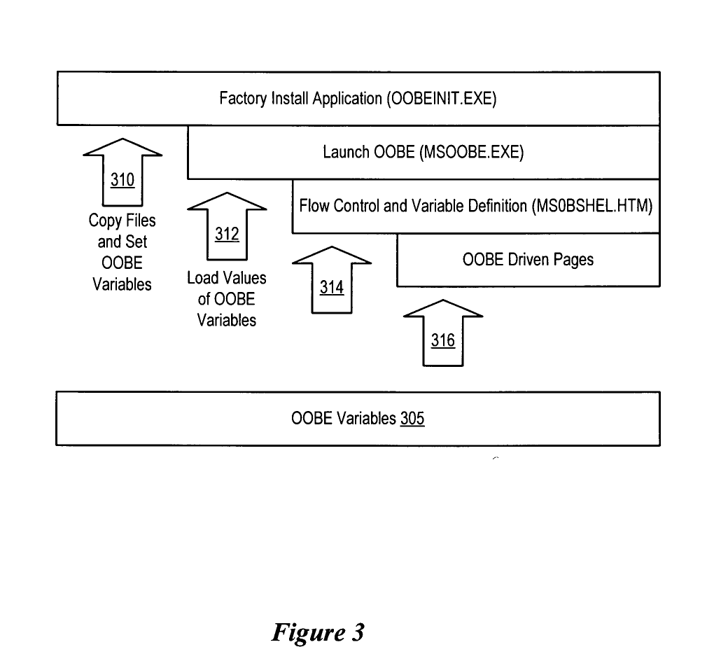

Referring to FIG. 3, a flow diagram of the various files used within an OOBE module is shown. More specifically, at a plurality of stages, various portions of an OOBE module interact with an OOBE variables file 305. Accordingly, when installing an OOBE module during a factory install process 110, the OOBE installation files (OOBEINIT.EXE) are copied to an information handling system. Any variables within the OOBE installation module are set from the variables stored within the OOBE variables file 305.

When an OOBE module is launched (e.g., OOBE.EXE), values are loaded 312 from the OOBE variables file 305. For example, if the OOBE module were setting forth an internet service provider (ISP) registration configuration, any changes to the configuration would only require changes to the OOBE variables relating to ISP registration configuration.

Any flow control or variable definition changes 314 (via, e.g., MSOBSHEL.HTM) are addressed by changes to the OOBE variables within the OOBE variables file 305. Hard code changes and additional branch processing are not needed.

For any OOBE module driven pages (such as e.g., ISP registration customized pages), any changes only occur within the OOBE configuration file 305, the HTML files reads the variables to the configuration file 305 to dynamically generate content and to handle any errors. Thus, option changes and page edits do not require hard code changes to add related statements in each .HTM file of the OOBE module.

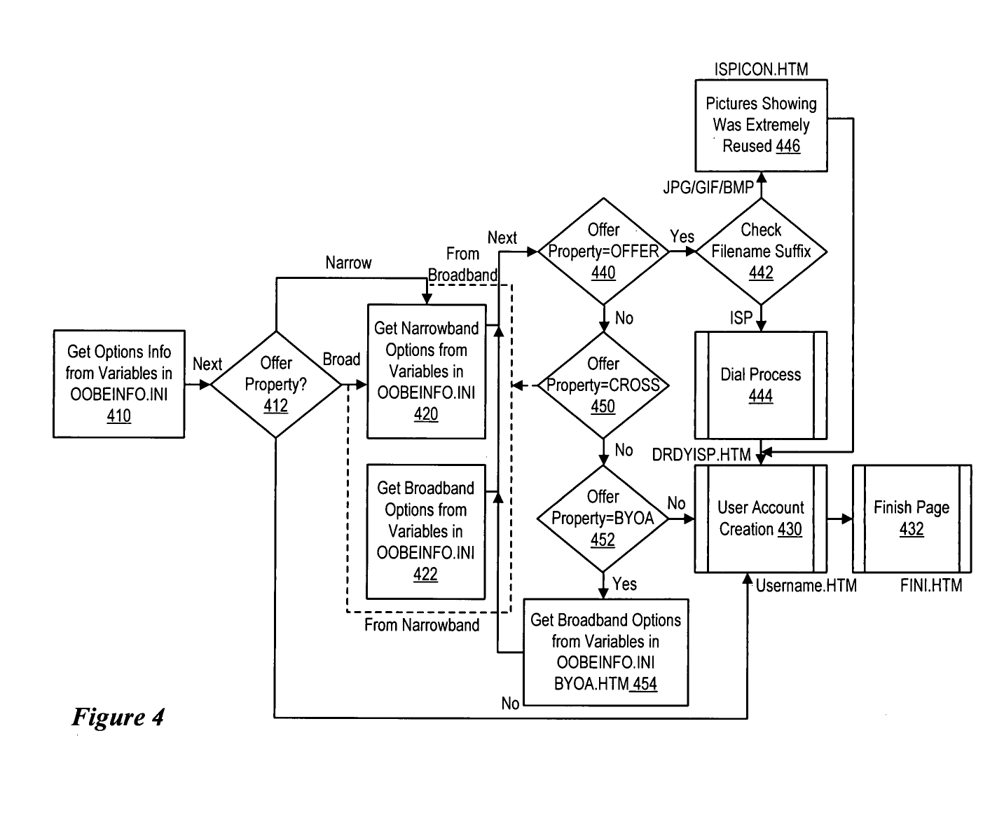

Referring to FIG. 4, a flow diagram of an example process for developing an out of box experience module is shown. More specifically, the process starts with obtaining options information from the variables that are stored within the OOBE variables file 305 at step 410. Next, at step 412, the process determines which type of ISP offers to present during the OOBE module execution via an offer property variable. These offers may be based upon information obtained from a customer during an information handling system configuration process. The offers can include a narrow band offer, a broadband offer, a combination of narrow band and broadband offers or no offer at all.

If a narrow band offer is being presented, then the process obtains narrow band options from the variables within the OOBE variables file 305. If a broadband offer is being presented, then the process obtains broadband options from the variables within the OOBE variables file 305. If no offer is presented, then the process proceeds to a user account creation step 430 where a user account creation information is presented via a hypertext markup language (HTML) type file (usemame.htm). Next a finish page is presented via a HTML file (fini.htm) at step 432.

After either the narrow band options or the broadband options are obtained, then the process accesses the offer property variable at step 440. If the offer property variable is set to offer, then only one of the narrow band or broadband offers are presented and the process proceeds to check the filename suffix at step 442. The check filename suffix determines the specific action to take after the choice of each ISP offer.

If the filename suffix is set to dial up, then the process presents dial process information via a drdyisp.htm file at step 444. The process then proceeds to creating a user account at step 430.

If the filename suffix is set to logo icon (via an ISPICON.HTM file), then the process presents a series of preset ISP vendor's logo information at step 446. The logo information may be presented via JPG, GIF or BMP type files. The process then proceeds to creating a user account (via a username.HTM file) at step 430.

If the offer property variable is set to cross as determined at step 450, then both narrow band and broadband offers are to be presented via the OOBE module, and the process returns to obtain the additional options information from the OOBE variables file 305.

If the offer property variable is set to byoa as determined at step 452, then the user's ISP is to be used and the broadband options from the variables within the OOBE variables file 305 are presented via a BYOA.HTM file at 454.

If the offer property variable was not set to offer, cross or BYOA, then the process proceeds to the user account creation step 430 where a user account creation information is presented via the username.htm file.

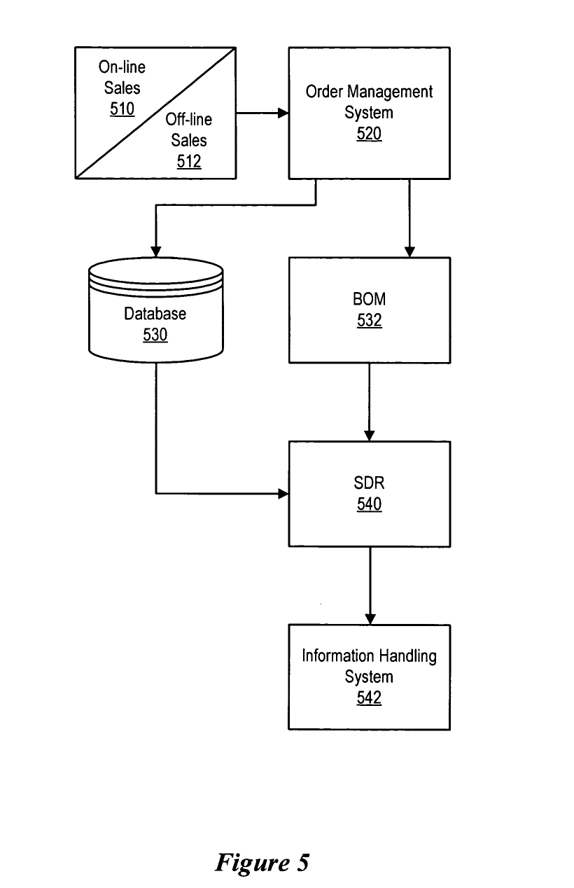

Referring to FIG. 5, a flow diagram of the configuration of an information handling system to include the out of box experience module is shown. When registration or customization information is obtained either via on-line sales 510 or via off-line (e.g., telephone) sales 512, the information is provided to an order management system 520 which interacts with the factory in which the system is manufactured. The order management system 520 stores this information to a database 530 as well as to a Bill of Materials (BOM) 532 which is associated with a particular system being manufactured or peripheral being purchased. It will be appreciated that one or both the database 530 or the BOM 532 may be used to transfer the information from the customer order to a particular information handling system. The information is then stored in a system descriptor record (SDR) which is stored on the memory of the information handling system 542 being manufactured. The database 530 includes a plurality of components that are each identified by a unique component identifier (referred to as an INFO part). The SDR for a particular system includes a list of all of the component identifiers for a particular system. Accordingly, the registration or customization information that is obtained from the customer is stored on the system that is manufactured for that customer. One of the component identifiers corresponds to an OOBE module which is to be installed during the installation process.

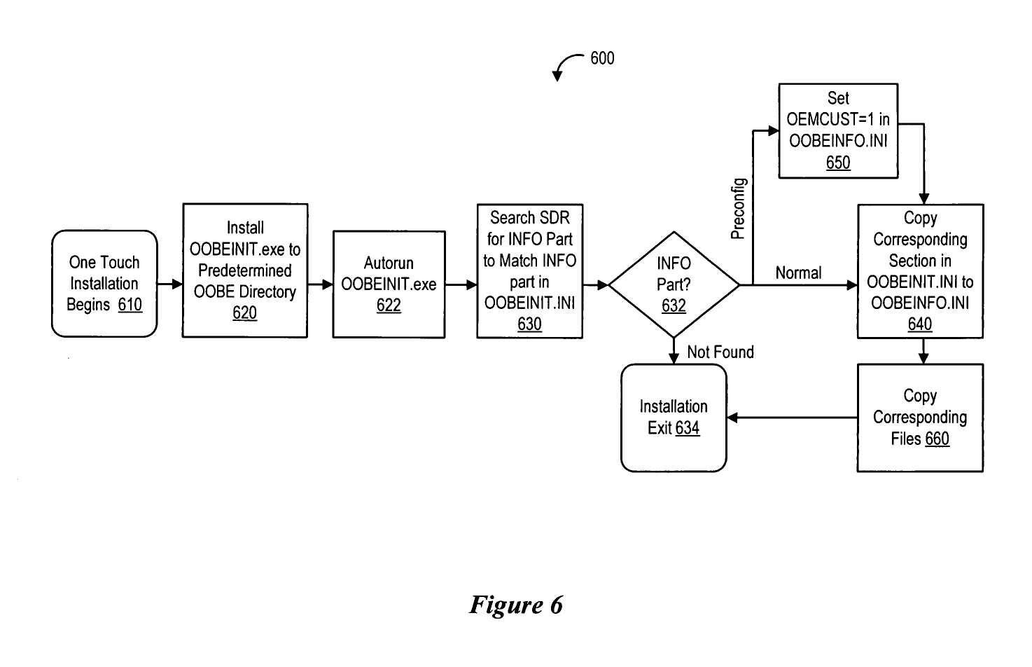

Referring FIG. 6, a flow diagram of an out of box experiences module factory install process 600 is shown. More specifically, the one touch factory install process 600 for the OOBE module 305 begins at step 610. Windows Based Installation (WBI) is a step in factory installation in which executable installation packages queue in a window setup process and setup their own program files and set system settings.

An OOBE initialization module (OOBEINIT.exe) is written to a predetermined OOBE directory (e.g., c:\dell\$(PN)) within the information handling system to which the OOBE module is being installed at step 620. Next, the OBBE initialization module is automatically executed at step 622. Next, the process searches the SDR of the particular information handling system for an INFO part that matches the INFO part information that is stored within the OOBE initialization module at step 630. If the OOBE module corresponding to the component identifier is not present, as determined by step 632, then the one step factory installation process 600 exits at step 634.

If the component identifier corresponds to a normal (i.e., non-customized) OOBE module, then an appropriate section of the OOBE initialization module is copied to the OOBE variables file at step 640. If the component identifier corresponds to a preconfigured (i.e., a customized) OOBE module, then a customized OOBE indication (OEMCUST) within the OOBE variables file is set at step 650. After the customized OOBE indication is set, then the appropriate section of the OOBE initialization module is copied to the OOBE variables file at step 640. After the information is coped to the OOBE variables file, then the files corresponding to the variables within the OOBE variables file (e.g., .htm files that are identified within the OOBE variables file) are copied to the information handling system at step 660.

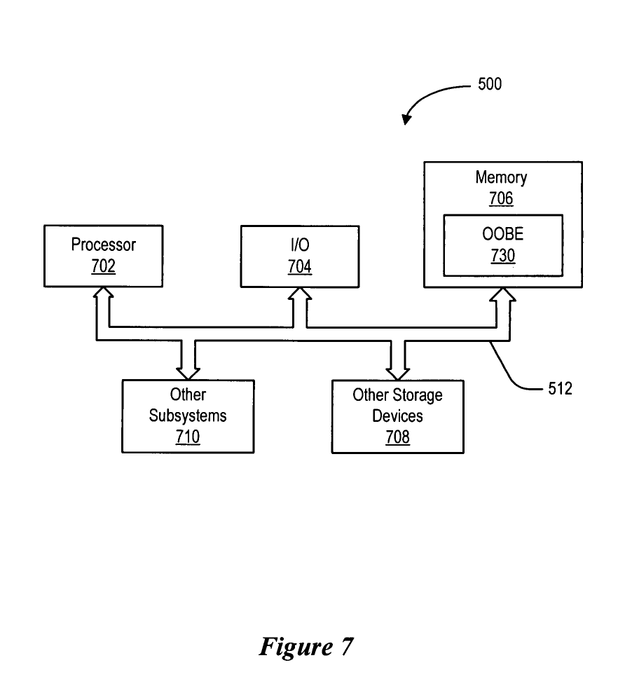

Referring to FIG. 7, a system block diagram of an information handling system 700 is shown having an out of box experience module configured in accordance with the process of simplifying development of out of box experience modules. The information handling system 700 includes a processor 702, input/output (I/O) devices 704, such as a display, a keyboard, a mouse, and associated controllers, memory 706 including volatile memory such as random access memory (RAM) and non-volatile memory such as a hard disk and drive, and other storage devices 708, such as a floppy disk drive, a CD ROM drive and other memory devices, and various other subsystems 710, all interconnected via one or more buses 712.

The information handling system 700 includes an out of box experience module 730 stored within the memory 706.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for providing an out of box experience (OOBE) comprising:
providing an OOBE module and an OOBE variables file;
providing OOBE options to the OOBE module via the OOBE variables file;
customizing the out of box experience via the OOBE options in the OOBE variables file; and,
presenting the out of box experience via the OOBE module.

2. The method for providing an out of box experience (OOBE) of claim 1 wherein:
the OOBE options relate to internet service provider information.

3. The method for providing an out of box experience (OOBE) of claim 2 wherein:
the internet service provider information includes information regarding whether to present broadband or narrowband internet service provider information.

4. The method for providing an out of box experience (OOBE) of claim 1 wherein:
the OOBE options includes internet service provider logo information.

5. The method for providing an out of box experience (OOBE) of claim 1 wherein:
the OOBE options includes user account creation information.

6. The method for providing an out of box experience (OOBE) of claim 1 wherein:
the OOBE variables file includes hyper text markup language (HTML) type files based upon the OOBE options.

7. A method for developing an out of box experience (OOBE) comprising:
providing an OOBE module and an OOBE variables file;
standardizing the OOBE module;
customizing the out of box experience with OOBE options via variables in the OOBE variables file;
providing the variables in the OOBE variables file to the OOBE module; and,
presenting the out of box experience via the OOBE module.

8. The method of claim 7 wherein:
the OOBE options relate to internet service provider information.

9. The method of claim 8 wherein:
the internet service provider information includes information regarding whether to present broadband or narrowband internet service provider information.

10. The method of claim 7 wherein:
the OOBE options includes internet service provider logo information.

11. The method of claim 7 wherein:
the OOBE options includes user account creation information.

12. The method of claim 7 wherein:
the OOBE variables file includes hyper text markup language (HTML) type files based upon the OOBE options.

13. A method for installing an out of box experience (OOBE) module onto an information handling system comprising:
executing an OOBE initialization module, the OOBE initialization module accessing a component identifier, the component identifier identifying a particular out of box experience;
copying an OOBE module onto the information handling system;
copying variables from the OOBE variables file based upon the component identifier, the variables causing the OOBE module to execute in accordance with OOBE options, the OOBE options defining the particular out of box experience.

14. The method of claim 13 wherein:
the OOBE options relate to internet service provider information.

15. The method of claim 14 wherein:
the internet service provider information includes information regarding whether to present broadband or narrowband internet service provider information.

16. The method of claim 13 wherein:
the OOBE options includes internet service provider logo information.

17. The method of claim 13 wherein:
the OOBE options includes user account creation information.

18. The method of claim 13 wherein:
the OOBE variables file includes hyper text markup language (HTML) type files based upon the OOBE options.
